(19) United States
(12) Patent Application Publication
(10) Pub. No.: US 2010/0182337 A1
(43) Pub. Date: Jul. 22, 2010

(54) Imaging apparatus, image processing method, and storage medium storing image processing program

(76) Inventor: Ayako Asakura, Hino-shi (JP)

Correspondence Address: KENYON & KENYON LLP, ONE BROADWAY, NEW YORK, NY, 10004, US

(21) Appl. No.: 12/655,795

(22) Filed: Jan. 6, 2010

(30) Foreign Application Priority Data
Jan. 13, 2009 (JP) 2009-4382

(51) Int. Cl. G06T 7/00; G09G 5/02

(52) U.S. Cl. 345/594; 382/165

(57) ABSTRACT

An imaging apparatus includes an electronic viewfinder including a display device for displaying an image and an ocular optical system, a storage unit for storing information, an input unit for receiving an input operation relating to color conversion processing, a color conversion processing unit for performing color conversion processing corresponding to the input operation on the image, and a control unit for controlling the electronic viewfinder, the input unit, and the color conversion processing unit.

### TECHNICAL FIELD OF THE INVENTION

This invention relates to a technique for performing color conversion processing on an image.

### BACKGROUND OF THE INVENTION

A large number of people have a color recognition characteristic which means that they cannot recognize specific colors (color blindness) or find it difficult to recognize specific colors (color amblyopia). In the case of Japanese males, for example, approximately one in twenty has this type of color recognition characteristic. Hence, in devices that handle color images, it is desirable to perform appropriate color conversion processing on a color image so that the color image can be recognized by people who have this type of color recognition characteristic.

With regard to this point, JP2007-190113A discloses a technique for displaying a test image on a display, determining the color recognition characteristic of a user from a recognition result obtained from the user in relation to the test image, and correcting a tone of the color image in accordance with the determination result. By emphasizing a specific color that the user cannot (or finds difficult to) recognize, the color image can be made more easy to recognize.

### SUMMARY OF THE INVENTION

According to an aspect of the present invention, an imaging apparatus includes an electronic viewfinder which includes a display device for displaying an image and an ocular optical system, a storage unit which stores information, an input unit which receives an input operation relating to color conversion processing, a color conversion processing unit which performs color conversion processing corresponding to the input operation on the image, and a control unit which controls the electronic viewfinder, the input unit, and the color conversion processing unit.

According to another aspect of the present invention, an image processing method includes an image acquisition step for obtaining an image of an object, a storage step for storing the image, an information acquisition step for obtaining information relating to a color recognition characteristic, a color conversion step for performing color conversion processing on the image on the basis of the information, and an image display step for displaying an image resulting from the color conversion processing on a finder.

According to yet another aspect of the present invention, a computer-readable storage medium storing an image processing program is provided. The image processing program includes an image acquisition step for obtaining an image of an object, a storage step for storing the image, an information acquisition step for obtaining information relating to a color recognition characteristic, a color conversion step for performing color conversion processing on the image on the basis of the information, and an image display step for displaying an image resulting from the color conversion processing on a finder.

Embodiments and advantages of this invention will be described in detail below with reference to the attached figures.

### BRIEF DESCRIPTION OF THE DRAWINGS

FIG. 1 is a functional block diagram of a camera according to an embodiment of this invention.

FIG. 2 is a flowchart showing the content of a program relating to visibility adjustment/color conversion processing performed by a system controller.

FIG. 3 is a view showing an example of a confirmation message relating to visibility adjustment.

FIG. 4 is a view showing an example of a visibility adjustment image.

FIG. 5 is a view showing an example of a color conversion procedure menu.

FIG. 6 is a view showing an example of a manual adjustment screen.

FIG. 7 is a view showing an example of a color-converted image.

FIG. 8 is a view showing an example of an original color checking screen.

FIG. 9 is a view showing an example of a color recognition characteristic list.

FIG. 10 is a view showing an example of an image before and after color conversion processing.

FIG. 11 is a view showing an example of a color pattern used to determine a color recognition characteristic.

FIG. 12 is an example of a screen displayed when a storage image is stored in a storage medium.

### DESCRIPTION OF THE PREFERRED EMBODIMENTS

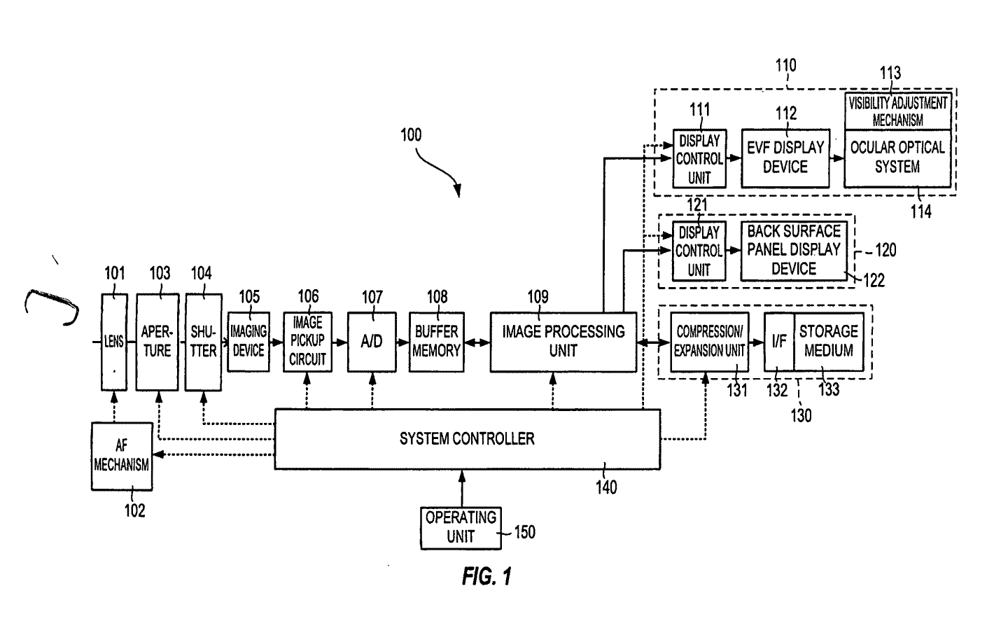

FIG. 1 is a functional block diagram of a camera 100 according to an embodiment of this invention. Here, the camera 100 is a digital still camera for picking up static images, but this invention may also be applied to a digital still camera having a moving image pickup function or a digital video camera that functions mainly to pick up moving images.

The camera 100 comprises a lens system 101, an AF mechanism 102, an aperture mechanism 103, a shutter 104, an imaging device 105, an image pickup circuit 106, an A/D converter 107, a buffer memory 108, an image processing unit 109, an electronic viewfinder (“EVF” hereafter) 110, a back surface panel 120, a recording unit 130, a system controller 140, and an operating unit 150.

The lens system 101 includes various lenses such as a focus lens for adjusting a focal point position and a zoom lens for adjusting a focal length. The AF mechanism 102 adjusts the focus by driving the lens system 101. Further, when the lens system 101 is a zoom lens system capable of power zoom, the AF mechanism 102 performs zoom adjustment. The aperture mechanism 103 includes an aperture provided on an optical path of the lens system 101 and a control mechanism for controlling the aperture. The shutter 104 controls an amount of time that light flux entering from the lens system 101 via the aperture mechanism 103 is incident on the imaging device 105.

The imaging device 105 converts the light flux from the lens system 101 into an electric signal through photoelectric conversion. The imaging device 105 is constituted by an image sensor such as a CCD or a CMOS, for example. The image pickup circuit 106 converts the electric signal transmitted from the imaging device 105 into an analog image signal. The A/D converter 107 converts the analog image signal transmitted from the image pickup circuit 106 into a digital image signal. The buffer memory 108 is constituted by an SDRAM which temporarily stores the digital image signal transmitted from the A/D converter 107 and a digital image signal generated by the image processing unit 109 (a color-converted image signal to be described below, image signals pertaining to the display of alphanumerical images including various image pickup information and various setting menus, and so on).

The image processing unit 109 performs various types of image processing such as color conversion processing, to be described below, and pixel count conversion processing on the digital image signal stored in the buffer memory 108 to generate an EVF image signal, a back surface panel image signal, and a recording image signal, and stores the generated signals temporarily in the buffer memory 108. In the following description, the processing that is performed on the digital image signal is expressed as processing performed on an “image” represented by the signal.

The EVF 110 is a look-into-type electronic viewfinder comprising a display control unit 111, an EVF display device 112, a visibility adjustment mechanism 113, and an ocular optical system 114. The visibility adjustment mechanism 113 may be omitted.

The EVF display device 112 is constituted by a liquid crystal panel. The display control unit 111 drives the EVF display device 112 on the basis of the EVF image signal transmitted from the image processing unit 109, whereby an EVF image is displayed on the EVF display device 112. In the following description, displaying an EVF image on the EVF display device 112 will be expressed simply as “displaying an image on the EVF 110”. The image display device used in this embodiment is not limited to an LCD, and organic EL, for example, may be used as the image display device.

The ocular optical system 114 is constituted by a plurality of lenses including a lens that is capable of moving in an optical axis direction, and is used to enlarge the image displayed on the EVF display device 112. A user views the EVF image displayed on the EVF display device 112 through the ocular optical system 114.

The visibility adjustment mechanism 113 is a mechanism that modifies a focal length of the ocular optical system 114 by moving at least one lens in the optical axis direction. By operating the visibility adjustment mechanism 113, the user can view the EVF display device 112 clearly in accordance with the visual power (eyesight) of his/her eyes. In other words, the user can view the image displayed on the EVF display device 112 in focus.

The back surface panel 120 comprises a display control unit 121 and a back surface panel display device 122.

The back surface panel display device 122 is constituted by a liquid crystal panel. The display control unit 121 drives the back surface panel display device 122 on the basis of the back surface panel image signal transmitted from the image processing unit 109, whereby a back surface panel image is displayed on the back surface panel display device 122. In the following description, displaying a back surface panel image on the back surface panel display device 122 will be expressed simply as “displaying an image on the back surface panel 120”.

The recording unit 130 comprises a compression/expansion unit 131, an interface 132, and a storage medium 133.

The compression/expansion unit 131 compresses the recording image signal transmitted from the image processing unit 109 using a system such as JPEG or MPEG, for example. Further, the compression/expansion unit 131 expands a compressed image signal stored in the storage medium 133 and stores the expanded image signal in the buffer memory 108. The interface 132 transmits data between the compression/expansion unit 131 and the storage medium 133. The storage medium 133 is a flash memory or the like such as a smart medium, an SD card or an xD picture card that can be attached to and detached from the interface 132.

The system controller 140 performs overall control of the respective units provided inside the camera 100. The system controller 140 comprises a CPU, a RAM, a flash memory, and so on, for example.

The system controller 140 performs overall control of the camera 100 by reading a program stored in the flash memory to the RAM and having the CPU execute the program. For example, the system controller 140 executes focus adjustment and zooming by controlling the AF mechanism 102 to control the lens system 101. Further, the system controller 140 performs aperture adjustment via the aperture mechanism 103 and controls a shutter speed by driving the shutter 104.

Furthermore, the operating unit 150, which is constituted by a plurality of buttons and dials including a release button, is connected to the system controller 140 such that the system controller 140 receives an input operation input into the operating unit 150 by the user and performs control corresponding to the input.

In particular, the system controller 140 controls the image processing unit 109. The image processing unit 109 performs color conversion processing corresponding to a color recognition characteristic of the user. Here, the user is assumed to have a color recognition characteristic that makes it impossible (color blindness) or difficult (color amblyopia) for him/her to recognize specific colors. By performing color conversion processing in the image processing unit 109, even this type of user can recognize a color image. During the color conversion processing, the user is required to view an image displayed on the EVF 110. Thus, external light can be prevented from affecting the color conversion processing. Moreover, even a user suffering from presbyopia or hypermetropia can perform color conversion-related processing appropriately.

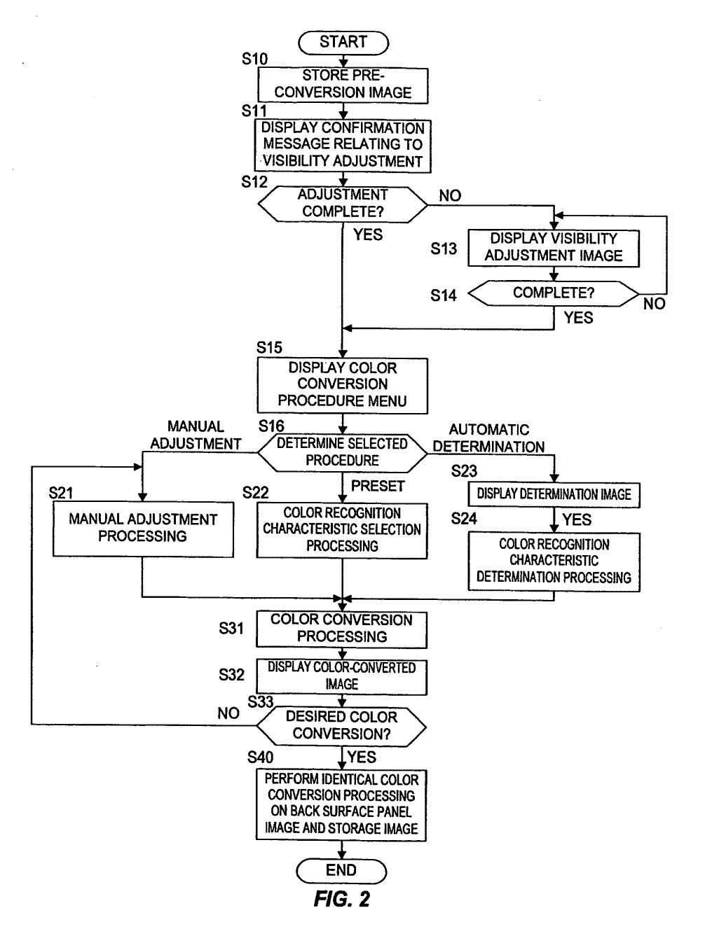

FIG. 2 is a flowchart showing the content of a program relating to visibility adjustment/color conversion processing executed by the system controller 140. The content of this processing will now be described in detail with reference to FIG. 2. This processing may be performed in real time.

The processing begins when the user performs a predetermined input operation on the operating unit 150. In the predetermined input operation, for example, the user operates the operating unit 150 to display a setting menu on the EVF 110 or the back surface panel 120 and selects an item relating to color conversion from the menu. A case in which the user performs this processing while looking through the EVF 110 is envisaged, and therefore a message or an image prompting the user to look into the EVF 110 may be displayed on the back surface panel 120.

First, in a step S10, the system controller 140 stores an image (a through image, a pickup image, an alphanumerical image, or the like) displayed on the EVF 110 immediately prior to the beginning of the processing as a pre-color conversion image.

Next, in a step S11 to a step S14, processing relating to visibility adjustment is performed. The reason for this is that when visibility adjustment is not performed in relation to the EVF 110, the user cannot view images displayed on the EVF 110 clearly, and it is therefore difficult for the user to select color conversion procedures appropriately and determine correctly whether or not the color conversion processing has been executed appropriately. Although the processing from the step S11 to the step S14 is preferably included, it is not an essential requirement.

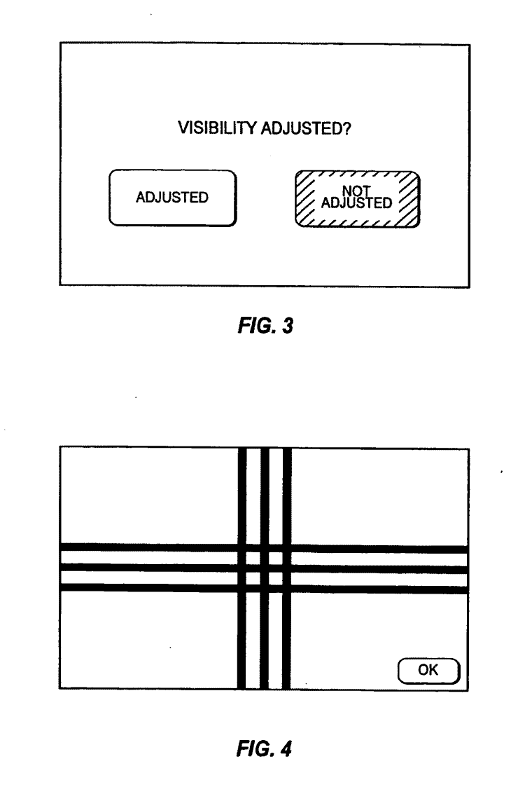

In the step S11, a confirmation message relating to visibility adjustment is displayed on the EVF 110, and the operating unit 150 becomes ready to receive an input operation from the user. FIG. 3 shows an example of the content of the confirmation message. In this example, “ADJUSTED”, indicating that visibility adjustment is complete, and “NOT ADJUSTED”, indicating that visibility adjustment is not complete, are displayed on the confirmation message. The user can select one of these choices by operating the operating unit 150.

In a step S12, a determination as to which of “ADJUSTED” and “NOT ADJUSTED” has been selected is made on the basis of the input operation input into the operating unit 150 by the user. When “ADJUSTED” is selected, the processing advances to a step S15 onward, and when “NOT ADJUSTED” is selected, the processing advances to a step S13. In the processing of the step S13, visibility adjustment is performed.

In the step S13, an image for use in the visibility adjustment (“visibility adjustment image” hereafter) is displayed on the EVF 110, and the operating unit 150 becomes ready to receive an input operation from the user. The visibility adjustment image is a suitable image for allowing the user to determine whether or not the image is in focus, for example an image constituted by a plurality of intersecting lines such as that shown in FIG. 4. The visibility adjustment image is constituted by luminance information alone so that the user can perform visibility adjustment regardless of the color recognition characteristic of the user. The user brings the visibility adjustment image into focus by operating the visibility adjustment mechanism 113 while viewing the visibility adjustment image. When visibility adjustment of the EVF 110 is complete, the user operates the operating unit 150 to select “OK”, which is displayed on the EVF 110 together with the visibility adjustment image.

In the step S14, a determination as to whether or not “OK” has been selected is made on the basis of the input operation input into the operating unit 150 by the user. When “OK” is selected, the processing advances to the step S15 onward, and when “OK” is not selected, the processing returns to the step S13.

When the visibility adjustment processing is complete, the system controller 140 performs processing relating to color conversion.

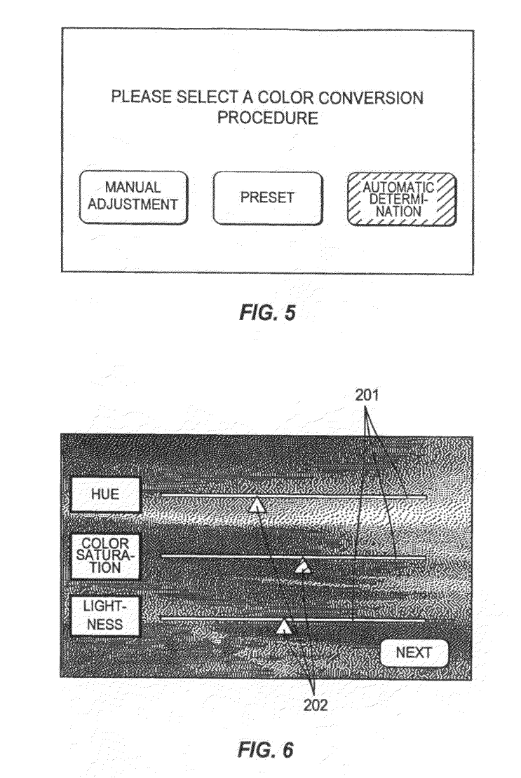

In the step S15, a color conversion procedure menu is displayed on the EVF 110, and the operating unit 150 becomes ready to receive an input operation from the user. As shown in FIG. 5, for example, “MANUAL ADJUSTMENT”, “PRESET”, and “AUTOMATIC DETERMINATION” are included on the menu as color conversion procedures. The user selects one of the procedures by operating the operating unit 150.

In a step S16, a determination is made as to which of the color conversion procedures has been selected. When “MANUAL ADJUSTMENT” is selected, the processing advances to a step S21, when “PRESET” is selected, the processing advances to a step S22, and when “AUTOMATIC DETERMINATION” is selected, the processing advances to a step S23.

When “MANUAL ADJUSTMENT” is selected, the processing advances to the step S21. In the step S21, a manual adjustment screen is displayed on the EVF 110, and the operating unit 150 becomes ready to receive an input operation from the user. The manual adjustment screen displays current set values relating to hue, color saturation, and lightness (to be referred to collectively as “color conversion parameters” hereafter). A screen such as that shown in FIG. 6, for example, is used to display the color conversion parameters. In FIG. 6, the color conversion parameters are displayed visually using slide bars 201. The user can modify the color conversion parameters individually by operating the operating unit 150 to move sliders 202 disposed on the slide bars 201.

At this time, the color conversion processing is performed on a pre-color conversion image on the basis of the color conversion parameters being modified. A color-converted image is displayed on the EVF 110 as background so that the user can check the image at any time. Further, “NEXT” is displayed on the screen together with the image. When the user selects “NEXT” by operating the operating unit 150, the color conversion parameters are fixed and the processing advances to a step S31.

In the step S31, color conversion processing is performed on the pre-color conversion image in the image processing unit 109 on the basis of the fixed color conversion parameters, and as a result, the color-converted image is obtained.

In a step S32, the color-converted image is displayed on the EVF 110, and the operating unit 150 becomes ready to receive an input operation from the user.

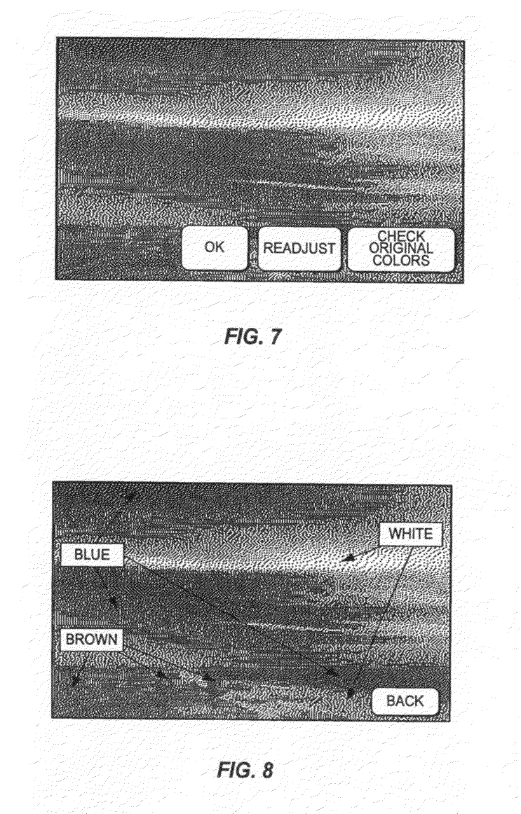

FIG. 7 shows an example of the color-converted image, which is displayed on the EVF 110 together with “OK”, “CHECK ORIGINAL COLORS”, and “READJUST”. The user views the color-converted image displayed on the EVF 110 to confirm that the color conversion has been performed as desired. At this time, the user checks the image by looking into the EVF 110, and therefore the effects of external light, presbyopia, hypermetropia, and so on are eliminated as far as possible. As a result, the user can determine appropriately whether or not the color conversion has been performed as desired. When the color conversion has been performed as desired, the user operates the operating unit 150 to select “OK”, and when the color conversion has not been performed as desired, the user operates the operating unit 150 to select “READJUST”.

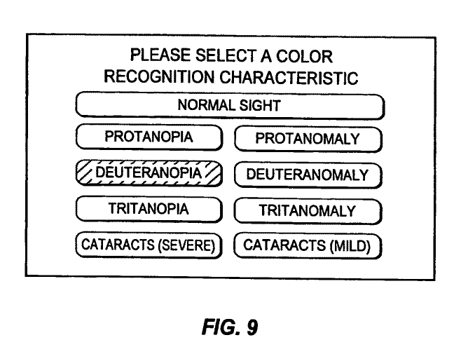

When the user selects “CHECK ORIGINAL COLORS” at this time, an original color checking screen shown in FIG. 8 is displayed on the EVF 110, and the operating unit 150 becomes ready to receive an input operation from the user. FIG. 8 shows a display example in a case where the user suffers from tritanopia. In the case of tritanopia, blue cannot be recognized, and therefore the sea and the sky are displayed in red. At the same time, original color information is displayed on the sea and the sky using alphabetic characters and arrows to indicate that the original color thereof is blue. If necessary, color conversion may also be performed on clouds, waves and rocks. In this case, as shown in FIG. 8, original color information and arrows may be displayed on these parts also.

Hence, on the original color checking screen, the names of the original colors are displayed on the color-converted image in the form of alphabetic information, and therefore the user can comprehend the basic original colors prior to color conversion. It should be noted that “BACK” is displayed on the screen together with the image. When the user operates the operating unit 150 to select “BACK”, the screen shown in FIG. 7 is displayed again.

In a step S33, the input operation input into the operating unit 150 by the user is determined. When “OK” is selected, the processing advances to a step S40, and when “READJUST” is selected, the processing returns to the step S21. In the step S21, the colors are readjusted.

Meanwhile, when “PRESET” is selected, the processing advances to the step S22. In this case, a pre-prepared list of color recognition characteristics is displayed. When the user selects a characteristic corresponding to his/her own color recognition characteristic, corresponding color conversion processing is performed.

More specifically, the list of color recognition characteristics shown in FIG. 9 is displayed on the EVF 110, and the operating unit 150 becomes ready to receive an input operation from the user. The list includes three types of color blindness, three types of color amblyopia, and cataracts (mild, severe), although the color recognition characteristics are not limited to those on the list. The user selects one color recognition characteristic by operating the operating unit 150.

Once a color recognition characteristic has been selected, the processing advances to the step S31. In the step S31, color conversion processing corresponding to the selected color recognition characteristic is performed on the pre-color conversion image, whereby the color-converted image is obtained. The content of the color conversion processing corresponding to the color recognition characteristic is stored in the flash memory or the like in advance.

In the color conversion processing, processing is performed on the basis of the selected color recognition characteristic to make the color image easier to see. The color conversion processing includes, for example, processing to emphasize a specific color that is difficult to recognize on the basis of the selected color recognition characteristic, processing to soften colors other than the specific color, processing to emphasize a boundary portion between adjacent regions in colors that are difficult to distinguish using a recognizable color, processing to replace the specific color with a different, recognizable color, and so on. In the color conversion processing, these processes are employed alone or, if necessary, in combination.

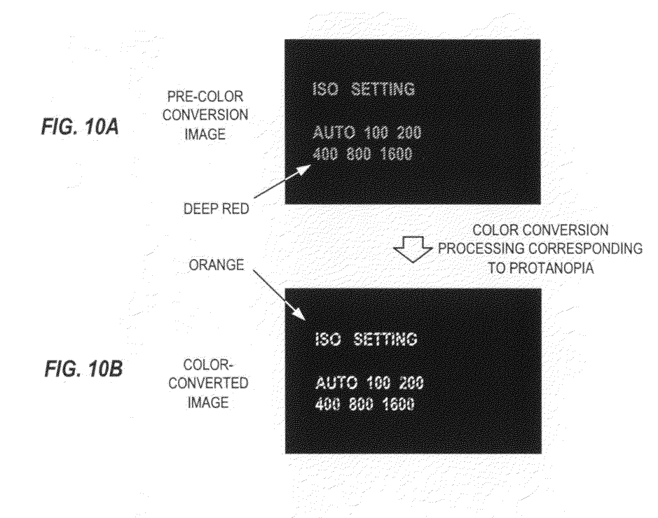

FIGS. 10A and 10B show examples of an image before and after the color conversion processing. When the color recognition characteristic of the user corresponds to protanopia, deep red appears as black, and therefore, when deep red characters are depicted on a black background, as shown in FIG. 10A, the characters are difficult to recognize. However, when protanopia is selected in the step S22, color conversion processing to replace deep red with orange, bright red, or the like is performed on the pre-color conversion image as shown in FIG. 10B. As a result, a color-converted image having characters that can be recognized even by a user suffering from protanopia is generated.

Processing following the color conversion processing is identical to that performed during manual adjustment. More specifically, the color-converted image is displayed on the EVF 110 (step S32), a determination as to whether or not color conversion has been performed as desired is made on the basis of an input operation input into the operating unit 150 by the user (step S33), and when color conversion has been performed as desired, the processing advances to the step S40. When readjustment is required, on the other hand, the processing advances to the step S21, where the user can readjust (manually adjust) the color conversion parameters as required.

Meanwhile, when “AUTOMATIC DETERMINATION” is selected, the processing advances to the step S23. In the step S23, color patterns for determining color recognition characteristics are displayed, and the color recognition characteristic of the user is determined from the manner in which the user recognizes the color patterns. Color conversion processing corresponding to the determined color recognition characteristic is then performed.

More specifically, a plurality of color patterns prepared in advance are displayed in sequence on the EVF 110 one at a time, and the operating unit 150 becomes ready to receive an input operation from the user.

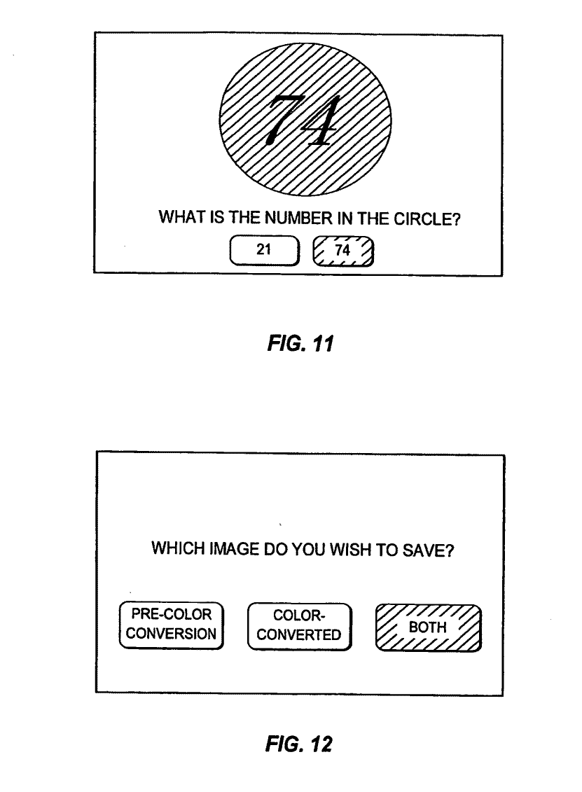

The color patterns used during color recognition characteristic determination have varying recognition characteristics according to the color recognition characteristic. The color patterns include patterns that are difficult for a person having a specific color recognition characteristic to recognize and patterns that are recognized differently according to the color recognition characteristic. As shown in FIG. 11, a question for the user is displayed on the EVF 110 together with the color pattern. The user inputs an answer to the question by operating the operating unit 150. When answers to all of the questions have been input, the processing advances to a step S24. Information relating to the plurality of color patterns is included in the content of the answers.

In the step S24, the manner in which the user recognized the color patterns is determined from the answers given by the user, and the color recognition characteristic of the user is determined on the basis thereof.

Once the color recognition characteristic of the user has been determined, the processing advances to the step S31. In the step S31, color conversion processing corresponding to the determined color recognition characteristic is performed on the pre-color conversion image, whereby the color-converted image is obtained. The content of the color conversion processing corresponding to the color recognition characteristic is stored in the flash memory or the like in advance.

Processing following the color conversion processing is identical to that performed during manual adjustment. More specifically, the color-converted image is displayed on the EVF 110 (step S32), a determination as to whether or not color conversion has been performed as desired is made on the basis of an input operation input into the operating unit 150 by the user (step S33), and when color conversion has been performed as desired, the processing advances to the step S40. When readjustment is required, on the other hand, the processing advances to the step S21, where the user can readjust (manually adjust) the color conversion parameters as required.

In the step S40, identical color conversion processing to that performed in the step S31 is executed on the back surface panel image and the storage image by the image processing unit 109. Thus, a color-converted back surface panel image and a color-converted storage image are generated. The back surface panel image is displayed on the back surface panel 120, and the storage image is stored in the storage medium 133 if necessary.

When the storage image is stored in the storage medium 133, the user may wish to store the pre-color conversion storage image as well as the color-converted storage image. Therefore, when the color conversion processing is performed on the storage image, the pre-color conversion storage image is not discarded, and instead, kept in the buffer memory 108. Further, a menu such as that shown in FIG. 12 is displayed on the EVF 110 or the back surface panel 120, and the operating unit 150 becomes ready to receive an input operation from the user. Thus, the user may select the pre-color conversion storage image, the color-converted storage image, or both images as the image to be stored in the storage medium 133.

Once the processing described above has been executed, the image processing unit 109 executes identical color conversion processing to that performed in the step S31 on the EVF image, the back surface panel image and the storage image until the processing described above is executed again.

Next, advantages of the above visibility adjustment/color conversion processing will be described.

According to the processing described above, color conversion processing is performed on an image displayed on the EVF 110 while the user views the image. At this time, the user looks into the EVF 110, and therefore the effects of external light, presbyopia, hypermetropia, and so on are eliminated as far as possible. As a result, the color conversion processing (color conversion procedure selection, color-converted image confirmation, and so on) can be performed accurately.

Further, in the processing described above, the color recognition characteristic of the user can be determined using the color patterns for determining the color recognition characteristic, and color conversion processing can be performed in accordance with the determined color recognition characteristic. Therefore, the user is not required to perform a detailed adjustment operation, and even when the user does not know which color recognition characteristics he/she has, color conversion processing corresponding to the color recognition characteristic of the user can be performed easily and appropriately. The color patterns are displayed on the EVF 110, and therefore the color recognition characteristic of the user can be determined accurately while excluding the effects of external light, presbyopia, hypermetropia, and so on.

Further, the user can select a characteristic corresponding to his/her own color recognition characteristic from a pre-prepared list of color recognition characteristics, and color conversion processing corresponding to the selected color recognition characteristic can be performed. Hence, color conversion processing corresponding to the color recognition characteristic of the user can be performed easily and appropriately while reducing the load on the user.

Further, although the color recognition characteristic of the user can be classified as one of several types, the manner in which colors are perceived vanes even among people having the same characteristic, and moreover, each user has different color preferences. In the above processing, the colors of the color-converted image can be readjusted (manually adjusted), enabling more detailed color conversion, and therefore the colors of the color-converted image can be brought closer to the colors desired by the user. Furthermore, using this function, a user who has normal sight can adjust the colors of an image to preferred colors.

Further, in the processing described above, color conversion processing is performed after visibility adjustment is executed on the EVF 110, and therefore color conversion procedure selection and color-converted image confirmation can be performed in focus. As a result, the color conversion processing can be performed appropriately. Moreover, an image including only luminance information is used during visibility adjustment, and therefore visibility adjustment can be performed on the EVF 110 correctly without being affected by the color recognition characteristic of the user.

Further, when the storage image is stored in the storage medium 133, the user selects either the pre-color conversion image or the color-converted image, or both images, as the storage image, whereupon the selected storage image is stored in the storage medium 133. Thus, it is possible to respond to a case in which the user wishes to store the pre-color conversion image as well as the color-converted image.

An embodiment of this invention was described above, but the above embodiment is merely an example of application of the invention, and the technical scope of this invention is not limited to the specific constitutions of the embodiment.

This application claims priority based on Japanese Patent Application No. 2009-4382, filed with the Japan Patent Office on Jan. 13, 2009, the entire content of which is incorporated into this specification.

What is claimed is:

1. An imaging apparatus comprising:
an electronic viewfinder which includes a display device for displaying an image and an ocular optical system;
a storage unit which stores information;
an input unit which receives an input operation relating to color conversion processing;
a color conversion processing unit which performs color conversion processing corresponding to the input operation on the image; and
a control unit which controls the electronic viewfinder, the input unit, and the color conversion processing unit.

2. The imaging apparatus as defined in claim 1, wherein the storage unit stores at least one of a list of color recognition characteristics and color patterns having different recognition characteristics according to the color recognition characteristics as the information,
the control unit determines a color recognition characteristic on the basis of the color patterns or an input operation relating to the list of color recognition characteristics, and
the color conversion processing unit performs color conversion processing corresponding to a determination result relating to the color recognition characteristic on the image as the color conversion processing.

3. The imaging apparatus as defined in claim 1, wherein the storage unit stores at least information relating to a hue, a color saturation, and a lightness as the information, and
the color conversion processing unit performs color conversion processing based on an input operation relating to at least one of the hue, the color saturation, and the lightness on the image as the color conversion processing.

4. The imaging apparatus as defined in claim 1, wherein the color conversion processing unit readjusts a color of the image following the color conversion processing.

5. The imaging apparatus as defined in claim 1, wherein the color conversion processing unit performs the color conversion processing on at least one of a through image, a pickup image, and an alphanumerical image.

6. The imaging apparatus as defined in claim 1, wherein the electronic viewfinder includes a visibility adjustment mechanism for modifying a focal length of the ocular optical system.

7. The imaging apparatus as defined in claim 6, wherein the storage unit stores an image for use in a visibility adjustment.

8. The imaging apparatus as defined in claim 7, wherein the image for use in the visibility adjustment includes only luminance information.

9. The imaging apparatus as defined in claim 1, wherein the storage unit stores at least one of the image prior to the color conversion processing and the image following the color conversion processing.

10. An image processing method comprising:
an image acquisition step for obtaining an image of an object;
a storage step for storing the image;
an information acquisition step for obtaining information relating to a color recognition characteristic;
a color conversion step for performing color conversion processing on the image on the basis of the information; and
an image display step for displaying an image resulting from the color conversion processing on a finder.

11. The image processing method as defined in claim 10, wherein, in the information acquisition step, the information is obtained by displaying color patterns having different recognition characteristics according to the color recognition characteristic.

12. The image processing method as defined in claim 10, wherein, in the information acquisition step, the information is obtained by displaying a list of color recognition characteristics.

13. The image processing method as defined in claim 10, wherein, in the information acquisition step, information relating to a hue, a color saturation, and a lightness is displayed, whereupon the color conversion processing is performed.

14. The image processing method as defined in claim 11, wherein the color conversion step includes a step for readjusting a color of the image resulting from the color conversion processing.

15. The image processing method as defined in claim 10, wherein, in the color conversion step, the color conversion processing is performed on at least one of a through image, a pickup image, and an alphanumerical image.

16. The image processing method as defined in claim 10, further comprising an adjustment step for adjusting a visibility.

17. The image processing method as defined in claim 16, wherein, in the adjustment step, an image for use in a visibility adjustment is displayed.

18. The image processing method as defined in claim 17, wherein the image for use in the visibility adjustment includes only luminance information.

19. The image processing method as defined in claim 10, wherein the storage step includes a step for storing at least one of the image prior to the color conversion processing and the image following the color conversion processing.

20. A computer-readable storage medium storing an image processing program, wherein the image processing program comprises:
an image acquisition step for obtaining an image of an object;
a storage step for storing the image;
an information acquisition step for obtaining information relating to a color recognition characteristic;
a color conversion step for performing color conversion processing on the image on the basis of the information; and
an image display step for displaying an image resulting from the color conversion processing on a finder.
